(19) United States
(12) Patent Application Publication
(10) Pub. No.: US 2018/0090057 A1
(43) Pub. Date: Mar. 29, 2018

(54) DISPLAY DEVICE AND METHOD FOR CONTROLLING THE SAME

(71) Applicant: BOE TECHNOLOGY GROUP CO., LTD., Beijing (CN)

(72) Inventors: Xitong MA, Beijing (CN); Lihua GENG, Beijing (CN); Xiao ZHANG, Beijing (CN)

(73) Assignee: BOE TECHNOLOGY GROUP CO., LTD., Beijing (CN)

(21) Appl. No.: 15/678,845

(22) Filed: Aug. 16, 2017

(30) Foreign Application Priority Data
Sep. 23, 2016 (CN) 201610848871.8

(51) Int. Cl. G09G 3/32; G06T 7/00; G08G 1/097

(52) U.S. Cl. CPC G09G 3/32; G06T 7/001; G08G 1/097; G09G 2320/045; G09G 2330/08; G09G 2330/12; G09G 2360/147; G09G 2320/0233

(57) ABSTRACT

A display device and a method for controlling the same are provided. The display device includes: a plurality of light-emitting components arranged in a matrix form and divided into N groups, where N is an integer greater than 1; N driving circuits connected to the N groups of light-emitting components respectively, and each configured to drive a corresponding group of light-emitting components to emit light; and a control module, configured to control, based on a predetermined switching period, the N driving circuits to drive alternately the N groups of light-emitting components to emit light, to enable the display device to be switched among N display states, where merely one group of light-emitting components emit light in each display state.

### CROSS-REFERENCE TO RELATED APPLICATION

This application claims priority to Chinese Patent Application No. 201610848871.8 filed on Sep. 23, 2016, which is incorporated herein by reference in its entirety.

### TECHNICAL FIELD

The present disclosure relates to the field of display technology, and in particular to a display device and a method for controlling the same.

### BACKGROUND

In the related art, a traffic light commonly applies light-emitting diodes (LEDs) to display. However, a service life the LED is limited. When the LEDs of the traffic light are out of order, the traffic light cannot display normally, so the traffic may be adversely affected to a great extent.

### SUMMARY

A display device is provided in at least one embodiment of the present disclosure, including: a plurality of light-emitting components divided into N groups, where N is an integer greater than 1; N driving circuits connected to the N groups of light-emitting components respectively, and each configured to drive a corresponding group of light-emitting components to emit light; and a control module, configured to control, based on a predetermined switching period, the N driving circuits to drive alternately the N groups of light-emitting components to emit light, to enable the display device to be switched among N display states, where a part of the light-emitting components emit light in each display state.

Optionally, the light-emitting components are arranged in a matrix form and divided into a first group of light-emitting components and a second group of light-emitting components, where the first group of light-emitting components includes the light-emitting components in odd-numbered columns, and the second group of light-emitting components includes the light-emitting components in even-numbered columns; the display device includes a first driving circuit connected to the first group of light-emitting components and a second driving circuit connected to the second group of light-emitting components; and the display device is capable of being switched between a first display state in which the first driving circuit drives the first group of light-emitting components to emit light and a second display state in which the second driving circuit drives the second group of light-emitting components to emit light.

Optionally, the display device further includes an image acquisition unit, where the control module is further configured to: control the image acquisition unit, based on a predetermined acquisition period, to acquire images displayed by the display device, where the predetermined acquisition period is shorter than the predetermined switching period; compare each of the images with a stored standard image; and determine that the display device is in an abnormal display state in the case that a similarity between each image and the stored standard image is smaller than a first threshold.

Optionally, the display device further includes a current parameter acquisition unit, where the control module is further configured to: control the current parameter acquisition unit, based on a predetermined acquisition period, to acquire a current parameter of the driving circuit working in a current display state, where the predetermined acquisition period is shorter than the predetermined switching period; compare the current parameter with a stored standard parameter; and determine that the display device is in an abnormal display state in the case that a difference between the current parameter and the stored standard parameter is larger than a second threshold.

Optionally, the display device further includes an alarm module configured to transmit information about the abnormal display state of the display device to a control center of the display device in the case that the display device is in the abnormal display state.

Optionally, the control module is further configured to switch the display device from a current display state to another display state and stop switching the display state of the display device; or determine a position of a faulty light-emitting component, select the light-emitting component adjacent to the faulty light-emitting component as a substitute light-emitting component, and enable the driving circuit corresponding to the substitute light-emitting component to drive the substitute light-emitting component to emit light.

Optionally, the light-emitting components are light-emitting diodes and an interval between adjacent light-emitting diodes is in the range from 3 millimeters to 5 millimeters.

Optionally, the image acquisition unit is a camera at a display side of the display device.

Optionally, a vertical distance between a plane where the camera is located and the display device is in the range from 5 centimeters to 10 centimeters, and a vertical distance between the camera and the display plane of the display device is in the range from 20 centimeters to 30 centimeters.

Optionally, the display device is a traffic light.

A method for controlling the above display device is further provided in at least one embodiment of the present disclosure, includes: controlling, based on a predetermined switching period, the N driving circuits to drive alternately the N groups of light-emitting components to emit light, to enable the display device to be switched among N display states, where a part of the light-emitting components emits light in each display state.

Optionally, the method further includes: controlling the image acquisition unit, based on a predetermined acquisition period, to acquire images displayed by the display device, where the predetermined acquisition period is shorter than the predetermined switching period; comparing each of the images with a stored standard image; and determining that the display device is in an abnormal display state in the case that a similarity between each image and the stored standard image is smaller than a first threshold.

Optionally, the method further includes: controlling the current parameter acquisition unit, based on a predetermined acquisition period, to acquire a current parameter of the driving circuit working in a current display state, where the predetermined acquisition period is shorter than the predetermined switching period; comparing the current parameter with a stored standard parameter; and determining that the display device is in an abnormal display state in the case that a difference between the current parameter and the stored standard parameter is larger than a second threshold.

Optionally, the predetermined acquisition period is in the range from 0.4 s to 0.6 s.

### BRIEF DESCRIPTION OF THE DRAWINGS

FIG. 1 is a schematic view of a display device in at least one embodiment of the present disclosure;

FIG. 2 is a flow chart of a method for controlling a display device in at least one embodiment of the present disclosure.

### DETAILED DESCRIPTION

In order to make the technical issues, the technical solutions and the advantages of the present disclosure more apparent, the present disclosure will be described hereinafter in details in conjunction with the drawings and embodiments.

In the related art, a traffic light commonly applies light-emitting diodes (LEDs) to display. However, a service life the LED is limited. When the LEDs of the traffic light are out of order, the traffic light cannot display normally, so the traffic may be adversely affected to a great extent. In view of this, the present disclosure provides in at least one embodiment a display device and a method for controlling the same, so as to guarantee the display device to display normally.

A display device is provided in at least one embodiment of the present disclosure, including: a plurality of light-emitting components divided into N groups, where N is an integer greater than 1; N driving circuits connected to the N groups of light-emitting components respectively, and each configured to drive a corresponding group of light-emitting components to emit light; and a control module, configured to control, based on a predetermined switching period, the N driving circuits to drive alternately the N groups of light-emitting components to emit light, to enable the display device to be switched among N display states, where only one group of the light-emitting components emit light in each display state.

According to the display device in at least one embodiment of the present disclosure, the light-emitting components of the display device are divided into a plurality of groups, and the display device has a plurality of display states. In each display state, only one group of light-emitting components emits light, while the other light-emitting components do not emit light, so the light-emitting components may emit light alternately, thereby prolonging the service life of the display device.

In at least one embodiment of the present disclosure, the light-emitting components are divided into a first group of light-emitting components and a second group of light-emitting components. The first group of light-emitting components includes the light-emitting components in odd-numbered columns, and the second group of light-emitting components includes the light-emitting components in even-numbered columns. The display device includes a first driving circuit connected to the first group of light-emitting components and a second driving circuit connected to the second group of light-emitting components. The display device is capable of being switched between a first display state and a second display state. The first driving circuit drives the first group of light-emitting components to emit light in the first display state, and the second driving circuit drives the second group of light-emitting components to emit light in the second display state, so the light-emitting components in odd-numbered columns and the light-emitting components in even-numbered columns may emit light alternately, thereby prolonging the service life of the display device.

Optionally, images displayed by the display device may be acquired periodically. It is able to determine whether the display device displays normally by comparing the acquired images with a standard image. The display device further includes an image acquisition unit. The control module is further configured to control the image acquisition unit, based on a predetermined acquisition period, to acquire images displayed by the display device, where the predetermined acquisition period is shorter than the predetermined switching period, and compare each of the images with a stored standard image; and determine that the display device is in an abnormal display state in the case that a similarity between each image and the stored standard image is smaller than a first threshold.

Optionally, a current parameter of the display device may be acquired periodically. It is able to determine whether the display device displays normally by comparing the acquired current parameter with a standard parameter. The display device further includes a current parameter acquisition unit. The control module is further configured to control the current parameter acquisition unit, based on a predetermined acquisition period, to acquire a current parameter of the driving circuit working in a current display state, where the predetermined acquisition period is shorter than the predetermined switching period; compare the current parameter with a stored standard parameter; and determine that the display device is in an abnormal display state in the case that a difference between the current parameter and the stored standard parameter is larger than a second threshold.

Optionally, the display device further includes an alarm module configured to transmit information about the abnormal display state of the display device to a control center of the display device in the case that the display device is in the abnormal display state, so the maintainer may be notified timely to repair the display device.

Optionally, the control module is further configured to switch the display device from a current display state to another display state and stop switching the display states of the display device in the case that the display device displays abnormally. In the case that the display device displays abnormally, it is indicated that some light-emitting components are out of order in the current display state, and then the display device is switched from the current display state to another display state and the display state switching of the display device is stopped, thereby guaranteeing the display device to display normally. In the case that the display device is a traffic light, the traffic light may be guaranteed to display normally, thereby avoiding the adverse effect to the traffic.

Optionally, the control module is further configured to determine a position of a faulty light-emitting component, select the light-emitting component adjacent to the faulty light-emitting component as a substitute light-emitting component, and enable the driving circuit corresponding to the substitute light-emitting component to drive the substitute light-emitting component to emit light, thereby guaranteeing the display device to display normally. In the case that the display device is a traffic light, the traffic light may be guaranteed to display normally, thereby avoiding the adverse effect to the traffic.

Optionally, the light-emitting components are LEDs. In the related art, an interval between adjacent LEDs of an LED display screen is from 6 mm to 10 mm. In at least one embodiment of the present disclosure, because the light-emitting components in odd-numbered columns and the light-emitting components in even-numbered columns emit light alternately, a density of the LEDs may be increased in order to achieve a required brightness. Therefore, in at least one embodiment of the present disclosure, an interval between adjacent light-emitting diodes is from 3 mm to 5 mm.

Optionally, the image acquisition unit is a camera at a display side of the display device.

Optionally, a vertical distance between a plane where the camera is located and the display device is from 5 cm to 10 cm, and a vertical distance between the camera and the display plane of the display device is 20 cm to 30 cm, so the camera may not shield light from the traffic light in the case that the display device is the traffic light.

A method for controlling the above display device is further provided in at least one embodiment of the present disclosure, including: controlling, based on a predetermined switching period, the N driving circuits to drive alternately the N groups of light-emitting components to emit light, to enable the display device to be switched among N display states, where only one group of light-emitting components emit light in each display state.

According to the display device in at least one embodiment of the present disclosure, the light-emitting components of the display device are divided into a plurality of groups, and the display device has a plurality of display states. In each display state, only one group of light-emitting components emits light, while the other light-emitting components do not emit light, so the light-emitting components may emit light alternately, thereby prolonging the service life of the display device.

Optionally, images displayed by the display device may be acquired periodically. It is able to determine whether the display device displays normally by comparing the acquired images with a standard image. The method further includes: controlling the image acquisition unit, based on a predetermined acquisition period, to acquire images displayed by the display device, where the predetermined acquisition period is shorter than the predetermined switching period; comparing each of the images with a stored standard image; and determining that the display device is in an abnormal display state in the case that a similarity between each image and the stored standard image is smaller than a first threshold.

Optionally, a current parameter of the display device may be acquired periodically. It is able to determine whether the display device displays normally by comparing the acquired current parameter with a standard parameter. The method further includes: controlling the current parameter acquisition unit, based on a predetermined acquisition period, to acquire a current parameter of the driving circuit working in a current display state, where the predetermined acquisition period is shorter than the predetermined switching period; comparing the current parameter with a stored standard parameter; and determining that the display device is in an abnormal display state in the case that a difference between the current parameter and the stored standard parameter is larger than a second threshold.

To be specific, the acquisition period is from 0.4 s to 0.6 s. Optionally, the acquisition period is 0.5 s.

The display device and the method for controlling the same in at least one embodiment of the present disclosure may be described hereinafter in details in conjunction with the drawings, by taking an example that the display device is a traffic light and the traffic light has a first display state and a second display state.

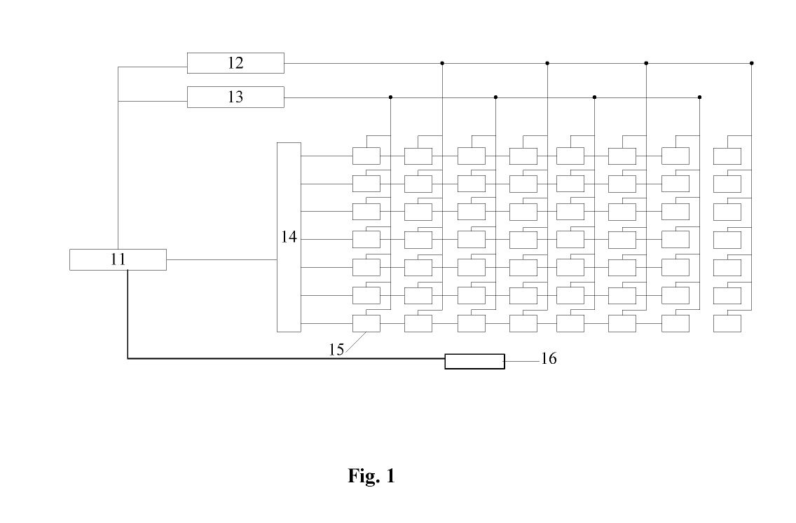

As shown in FIG. 1, the traffic light includes a plurality of LEDs 15 arranged in an array. The LEDs in odd-numbered columns are a first group of LEDs, and LEDs in even-numbered columns are a second group of LEDs. A driving circuit 13 and a driving circuit 14 are connected to the first group of LEDs and configured to control the first group of LEDs to emit light. A driving circuit 12 and the driving circuit 14 are connected to the second group of LEDs and configured to control the second group of LEDs to emit light. A control module 11 is connected to the driving circuit 12, the driving circuit 13 and the driving circuit 14 and configured to control working states thereof respectively and further enable to traffic light to be switched between the first display state and the second display state. In the first display state, the driving circuit 13 and the driving circuit 14 drive the first group of LEDs to emit light. In the second display state, the driving circuit 12 and the driving circuit 14 drive the second group of LEDs to emit light. In the related art, an interval between adjacent LEDs of an LED display screen is from 6 mm to 10 mm. In at least one embodiment of the present disclosure, because the light-emitting components in odd-numbered columns and the light-emitting components in even-numbered columns emit light alternately, a density of the LEDs may be increased in order to achieve a required brightness. Therefore, in at least one embodiment of the present disclosure, an interval between adjacent light-emitting diodes is from 3 mm to 5 mm.

Optionally, the control module 11 may be a Microcontroller Unit (MCU).

Optionally, the traffic light further includes a camera 16 at a display side of the traffic light. The camera 16 is connected to the control module 11. To be specific, the camera 16 is below the display plane of the display device and a vertical distance between a plane where the camera 16 is located and the display device is from 5 cm to 10 cm, and a vertical distance between the camera and the display plane of the display device is 20 cm to 30 cm, so the camera may not shield light from the traffic light. Optionally, the camera is a micro camera having a 720P@30 Hz video streaming.

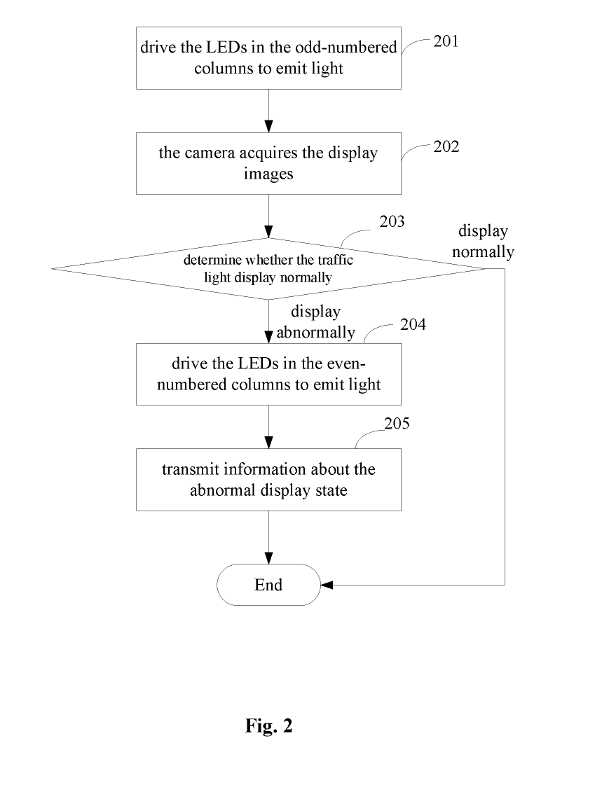

As shown in FIG. 2, the method for controlling the display device in at least one embodiment of the present disclosure includes:

Step 201: driving the LEDs in the odd-numbered columns to emit light.

To be specific, firstly the MCU drives the odd-numbered columns of LEDs to emit light to display images indicating traffic signals of the traffic light.

Step 202: acquiring, by the camera, the images displayed by the traffic light.

To be specific, the camera acquires the images displayed by the traffic light and transmits the images to the MCU. The MCU prestores standard images of the traffic light.

Step 203: comparing each of the acquired images with a prestored standard image, determining that the traffic light is in a normal display state in the case that a similarity between each image and the prestored standard image is larger than a threshold and ending the process, or determining that the traffic light is in an abnormal display state in the case that a similarity between each image and the prestored standard image is smaller than a threshold and proceeding to Step 204.

To be specific, the MCU captures every other 0.5 s the display images transmitted from the camera and compares each of the display images with the prestored standard image. In the case that a similarity between each image and the prestored standard image is larger than A, it is determined that the traffic light is in a normal display state. In the case that the similarity between each image and the prestored standard image is smaller than A, it is determined that the traffic light is in an abnormal display state. The parameter A can be adjusted, and a default value of A is 80%.

Step 204: driving the LEDs in the even-numbered columns to emit light.

In the case that the traffic light displays abnormally, it is indicated that some LEDs in the odd-numbered columns are out of order, and then the LEDs in the even-numbered columns may be driven, thereby guaranteeing the traffic light to display normally and avoiding the adverse effect to the traffic.

Step 205: transmitting information about the abnormal display state of the display device to a control center of the display device. Therefore, the maintainer may be notified timely to repair the display device.

The display state switching of the traffic light may be stopped and the LEDs in the even-numbered columns may keep display until the faulty LEDs in the odd-numbered columns are repaired.

Optionally, the MCU may prestore the standard parameter of the driving circuit of the traffic light which displays normally, acquire a current parameter of the driving circuit working in a current display state, and compare the acquired current parameter with the prestored standard parameter. In the case that a difference between the acquired current parameter and the prestored standard parameter is larger than a second threshold, it is determined that the traffic light is in an abnormal display state. In the case that the difference between the acquired current parameter and the prestored standard parameter is smaller than or equal to the second threshold, it is determined that the traffic light is in a normal display state.

In addition, in the case that the traffic light is in the abnormal display state, beside switching the display states of the traffic light, the MCU may determine a position of a faulty light-emitting component, select the light-emitting component adjacent to the faulty light-emitting component as a substitute light-emitting component, and enable the driving circuit corresponding to the substitute light-emitting component to drive the substitute light-emitting component to emit light, thereby guaranteeing the traffic light to display normally and avoiding the adverse effect to the traffic.

The functional members described in the specification are referred to as modules, so as to emphasize the independence of the implementation in a more particular manner.

According to the embodiments of the present disclosure, the modules may be implemented by software, so as to be executed by various processors. For example, an identified, executable code module may comprise one or more physical or logical blocks including computer instructions, and the module can be constructed as an image, a process or a function. Even so, the executable codes of the identified modules are unnecessary to be physically located together, but may comprise different instructions stored in different locations. When these instructions are logically combined together, they form the modules and achieve the prescribed purposes of the modules.

Actually, the executable code module may be a single instruction or a plurality of instructions, and can even be distributed at different code segments, in different programs, or across a plurality of memory devices. Also, operational data may be identified in the modules, implemented in any appropriate form, and organized in any data structure of an appropriate type. The operational data may be collected as a single data set, or distributed at different locations (including different memory devices), and may be at least partially present in a system or network merely as an electronic signal.

When the modules can be implemented by software, considering the current hardware level, a person skilled in the art can build a corresponding hardware circuit to achieve the corresponding function if taking no account of the cost. The hardware circuit comprises a conventional very-large-scale integration (VLSI) circuit, a gate array, an existing semiconductor such as a logic chip and a transistor, or other discrete components. The modules may further be implemented by a programmable hardware device, such as a field-programmable gate array, a programmable array logic device and a programmable logic device.

In the embodiments of the present disclosure, the order of the steps is not limited to the serial numbers thereof. For a person skilled in the art, any change in the order of the steps shall also fall within the scope of the present disclosure if without any creative effort.

The above are merely some embodiments of the present disclosure. A person skilled in the art may make further modifications and improvements without departing from the principle of the present disclosure, and these modifications and improvements shall also fall within the scope of the present disclosure.

What is claimed is:

1. A display device, comprising:
a plurality of light-emitting components divided into N groups, wherein N is an integer greater than 1;
N driving circuits connected to the N groups of light-emitting components respectively, and each configured to drive a corresponding group of light-emitting components to emit light; and
a control module, configured to control, based on a predetermined switching period, the N driving circuits to drive alternately the N groups of light-emitting components to emit light, to enable the display device to be switched among N display states, wherein a part of the light-emitting components emit light in each display state.

2. The display device according to claim 1, wherein
the light-emitting components are arranged in a matrix form and divided into a first group of light-emitting components and a second group of light-emitting components, wherein the first group of light-emitting components comprises the light-emitting components in odd-numbered columns, and the second group of light-emitting components comprises the light-emitting components in even-numbered columns;
the display device comprises a first driving circuit connected to the first group of light-emitting components and a second driving circuit connected to the second group of light-emitting components; and
the display device is capable of being switched between a first display state in which the first driving circuit drives the first group of light-emitting components to emit light and a second display state in which the second driving circuit drives the second group of light-emitting components to emit light.

3. The display device according to claim 2, further comprising an image acquisition unit, wherein the control module is further configured to:
control the image acquisition unit, based on a predetermined acquisition period, to acquire images displayed by the display device, wherein the predetermined acquisition period is shorter than the predetermined switching period;
compare each of the images with a stored standard image; and
determine that the display device is in an abnormal display state in the case that a similarity between each image and the stored standard image is smaller than a first threshold.

4. The display device according to claim 2, further comprising a current parameter acquisition unit, wherein the control module is further configured to:
control the current parameter acquisition unit, based on a predetermined acquisition period, to acquire a current parameter of the driving circuit working in a current display state, wherein the predetermined acquisition period is shorter than the predetermined switching period;
compare the current parameter with a stored standard parameter; and
determine that the display device is in an abnormal display state in the case that a difference between the current parameter and the stored standard parameter is larger than a second threshold.

5. The display device according to claim 3, further comprising an alarm module configured to transmit information about the abnormal display state of the display device to a control center of the display device in the case that the display device is in the abnormal display state.

6. The display device according to claim 3, wherein the control module is further configured to switch the display device from a current display state to another display state and stop switching the display state of the display device.

7. The display device according to claim 2, wherein the light-emitting components are light-emitting diodes and an interval between adjacent light-emitting diodes is in the range from 3 millimeters to 5 millimeters.

8. The display device according to claim 3, wherein the image acquisition unit is a camera at a display side of the display device.

9. The display device according to claim 8, wherein a vertical distance between a plane where the camera is located and the display device is in the range from 5 centimeters to 10 centimeters, and a vertical distance between the camera and the display plane of the display device is in the range from 20 centimeters to 30 centimeters.

10. The display device according to claim 1, wherein the display device is a traffic light.

11. The display device according to claim 4, further comprising an alarm module configured to transmit information about the abnormal display state of the display device to a control center of the display device in the case that the display device is in the abnormal display state.

12. The display device according to claim 3, wherein the control module is further configured to determine a position of a faulty light-emitting component, select the light-emitting component adjacent to the faulty light-emitting component as a substitute light-emitting component, and enable the driving circuit corresponding to the substitute light-emitting component to drive the substitute light-emitting component to emit light.

13. The display device according to claim 4, wherein the control module is further configured to, in the case that the display device in the abnormal display state, switch the display device from a current display state to another display state and stop switching the display state of the display device.

14. The display device according to claim 4, wherein the control module is further configured to determine a position of a faulty light-emitting component, select the light-emitting component adjacent to the faulty light-emitting component as a substitute light-emitting component, and enable the driving circuit corresponding to the substitute light-emitting component to drive the substitute light-emitting component to emit light.

15. A method for controlling the display device according to claim 1, comprises:
controlling, based on a predetermined switching period, the N driving circuits to drive alternately the N groups of light-emitting components to emit light, to enable the display device to be switched among N display states, wherein a part of the light-emitting components emits light in each display state.

16. The method according to claim 15, further comprising:
controlling the image acquisition unit, based on a predetermined acquisition period, to acquire images displayed by the display device, wherein the predetermined acquisition period is shorter than the predetermined switching period;
comparing each of the images with a stored standard image; and
determining that the display device is in an abnormal display state in the case that a similarity between each image and the stored standard image is smaller than a first threshold.

17. The method according to claim 15, further comprising:
controlling the current parameter acquisition unit, based on a predetermined acquisition period, to acquire a current parameter of the driving circuit working in a current display state, wherein the predetermined acquisition period is shorter than the predetermined switching period;
comparing the current parameter with a stored standard parameter; and
determining that the display device is in an abnormal display state in the case that a difference between the current parameter and the stored standard parameter is larger than a second threshold.

18. The method according to claim 16, wherein the predetermined acquisition period is in the range from 0.4 s to 0.6 s.

19. The method according to claim 17, wherein the predetermined acquisition period is in the range from 0.4 s to 0.6 s.
